(19) United States
(12) Patent Application Publication
(10) Pub. No.: US 2026/0316344 A1
(43) Pub. Date: Oct. 15, 2026

(54) RECONFIGURABLE WIND TURBINE BLADE MOULD

(71) Applicant: VESTAS WIND SYSTEMS A/S, Aarhus N (DK)

(72) Inventors: Alcibiades José CHUECOS, Ikast (DK); Betty LOUSDAL, Spjald (DK)

(21) Appl. No.: 19/119,059

(22) PCT Filed: Oct. 6, 2023
(86) PCT No.: PCT/DK2023/050238

§ 371 Date: Apr. 7, 2025

(30) Foreign Application Priority Data
Oct. 11, 2022 (DK) PA202270494

(51) Int. Cl. B29C 33/30; B29L 31/08

(52) U.S. Cl. CPC B29C 33/306; B29L 2031/085

(57) ABSTRACT

According to an aspect of the invention there is provided a reconfigurable mould assembly for the manufacture of wind turbine blades having different geometries. The mould assembly comprises a mould skin extending longitudinally in a spanwise direction and transversely in a chordwise direction. The mould skin defines a mould surface shaped to form a half shell of a wind turbine blade. The mould skin comprises a plurality of spanwise sections for arrangement end to end in a spanwise direction to form the half shell. The plurality of skin sections include one or more inboard skin sections for forming a root end of the half shell, and one or more outboard skin sections for forming a tip end of the half shell. The mould assembly further comprises a main frame comprising a series of independent main frame modules arranged end to end in the spanwise direction. The main frame modules include one or more inboard main frame modules for supporting the one or more inboard skin sections and one or more outboard main frame modules for supporting the one or more outboard skin sections. The mould assembly further comprises an intermediate support structure attached to a reverse side of each mould skin section. The intermediate support structure(s) attached to the inboard skin section(s) are releasably connectable to the inboard main frame module(s). The intermediate support structure(s) attached to the outboard skin section(s) are releasably connectable to the outboard main frame module(s).

### TECHNICAL FIELD

The present invention relates generally to wind turbine blades and more specifically to a reconfigurable mould for making a wind turbine blade.

### BACKGROUND

Modern utility-scale wind turbine blades typically comprise a composite outer shell. A blade may comprise two half shells which are formed separately and are subsequently joined together to form the outer shell. Each half shell may be formed by arranging a layup of reinforcing material on a substantially concave half shell mould surface before integrating the reinforcing material with a polymer resin and subsequently curing the resin.

Wind turbine blade manufacturers are designing increasingly longer wind turbine blades to capture more energy from the wind incident on the blades in use. For example, some modern wind turbine blades may extend over 70 m from a root end of the blade to a tip end. It follows that increasingly longer wind turbine blade moulds are required for forming the half shells of such blades. This presents a number of challenges.

Firstly, wind turbine blade moulds are typically expensive tools to design and manufacture due, at least in part, to their size and the complex contours of the mould surface which form the aerodynamic profile of the blade. Manufacturing different wind turbine blades typically requires different moulds, which increases the associated costs for the blade manufacturer. In some cases a blade manufacturer may opt to change or adjust an existing mould, e.g. changing the dimensions of the mould and mould surface, to manufacture a different blade. However, this typically involves permanently damaging the existing mould, e.g. through grinding and/or welding operations, and typically results in material wastage.

Further, moulds for large wind turbine blades take up a significant amount of floor space in a blade manufacturing facility, and storing multiple blade moulds may therefore be unfeasible for some manufacturing facilities. Finally, the size of the moulds can also be prohibitive to the manufacture of the mould because it is not possible or economically viable to transport such large tools. As such, blade moulds are typically manufactured at the blade manufacturing facility, which requires specialist mould manufacturing tools and equipment to be stored and used at the blade manufacturing facility. This places an additional constraint on the location of a blade manufacturing facility.

It is against this background that the present invention has been devised.

EP 3 715 080 A1 discloses a modular moulding device for creating a mold for a blade segment of a wind turbine blade, the modular moulding device comprising: a flexible support plate forming the mould for the blade segment, at least one bending apparatus comprising at least a first end and a second end, the at least one bending apparatus attached to the support plate and configured to bend the support plate from a first support plate shape to at least one second support plate shape, and at least one connection means, which is configured to removably connect the flexible support plate of the modular moulding device with at least one connection means of a flexible support plate of another modular moulding device.

WO2012/093136 discloses a mould for manufacturing a shell part of a wind turbine blade, the mould comprises a moulding surface with a shape that defines a surface of the shell part. The moulding surface has a longitudinal direction and a total length. The moulding surface comprises a flexible part extending in the longitudinal direction of the moulding surface and having a length corresponding to at least 1/10 of the total length of the moulding surface.

### SUMMARY

According to an aspect of the invention there is provided a reconfigurable mould assembly for the manufacture of wind turbine blades having different geometries. The mould assembly comprises a mould skin extending longitudinally in a spanwise direction and transversely in a chordwise direction. The mould skin defines a mould surface shaped to form a half shell of a wind turbine blade. The mould skin comprises a plurality of spanwise sections for arrangement end to end in a spanwise direction to form the half shell. The plurality of skin sections include one or more inboard skin sections for forming a root end of the half shell, and one or more outboard skin sections for forming a tip end of the half shell. The mould assembly further comprises a main frame comprising a series of independent main frame modules arranged end to end in the spanwise direction. The main frame modules include one or more inboard main frame modules for supporting the one or more inboard skin sections and one or more outboard main frame modules for supporting the one or more outboard skin sections. The mould assembly further comprises an intermediate support structure attached to a reverse side of each mould skin section. The intermediate support structure(s) attached to the inboard skin section(s) are releasably connectable to the inboard main frame module(s). The intermediate support structure(s) attached to the outboard skin section(s) are releasably connectable to the outboard main frame module(s).

The mould skin preferably comprises separate mould skin sections, i.e. the mould skin sections are separable from one another and form the mould skin when arranged together.

The reconfigurable mould assembly permits mould skin sections to be easily exchanged with mould skin sections having different geometries in order to make wind turbine blades having different dimensions. The substantial main frame modules may be re-used. The manufacture of longer blades may require additional main frame modules to be added, whilst main frame modules may be subtracted when making shorter blades. In particular the reconfigurable mould assembly facilitates reuse of substantial mould components, such as the main frame modules, to manufacture different blades. This reduces the capital expenditure of manufacturing a new blade design, and also greatly reduces the lead time required for manufacturing a new mould.

In some examples, the reconfigurable mould assembly may be referred to as a modular mould assembly, wherein each of the reconfigurable components of the mould may be referred to as mould modules. For example, the modular mould assembly may comprise a plurality of main frame modules, plurality of mould skin modules (skin sections), and an intermediate support module (intermediate support structure) attached to a reverse side of each mould skin module.

In some preferred examples, the main frame modules may be releasably connected to each other. This facilitates simple addition or subtraction of main frame modules from the mould assembly when reconfiguring the mould assembly for making blades of different lengths. This also ensures that the main frame modules maintain their structural integrity when reconfiguring the blade mould to manufacture different blades because the main frame modules can be separated without damaging the modules.

In some examples, the mould assembly may comprise a plurality of inboard main frame modules having substantially identical dimensions. Additionally or alternatively, the mould assembly may comprise a plurality of outboard main frame modules having substantially identical dimensions. Providing a plurality of main frame modules having substantially identical dimensions helps to reduce manufacturing cost and complexity when making the main frame modules. This also provides greater flexibility for interchangeably attaching other components or modules to the main frame modules because the interface between such other components and any of the plurality of substantially identical main frame modules is the same.

In some examples, the or each inboard main frame module may have a chordwise width that is larger than a chordwise width of the or each outboard main frame module. It will be appreciated that an inboard portion of a wind turbine blade is typically wider and/or thicker than an outboard portion of the blade. As such, the or each inboard skin section may be wider than the or each outboard skin section. Accordingly, the or each inboard main frame module may have a larger chordwise width than the or each outboard main frame module to provide the requisite stability and structural support for the or each wider inboard skin section. As noted previously, in preferred examples each inboard main frame module may have the same chordwise width.

In some examples, the mould assembly may further comprise a middle skin section for forming at least part of a middle section of the half shell between the root end and the tip end. This may facilitate the manufacture of a greater variety of blades using the mould assembly, without necessarily requiring new or different inboard and/or outboard skin section. The mould assembly may further comprise one or more middle main frame modules for supporting the middle skin section. The mould assembly may further comprise an intermediate support structure attached to a reverse side of the middle skin section. In preferred examples, the intermediate support structure may be releasably connectable to the one or more middle main frame modules. The releasable connection between the intermediate support structure and the or each middle main frame module facilitates a simple exchange of components when reconfiguring the mould assembly.

In some preferred examples, the mould assembly may include a plurality of middle skin sections. Providing a plurality of middle skin sections may facilitate finer adjustment of the overall mould skin for manufacturing a greater variety of blades in the reconfigurable mould. An intermediate support structure may be attached to a reverse side of each middle skin section. The intermediate support structures are preferably releasably connectable to the or each middle main frame modules. Further, the or each middle main frame module is preferably releasably connected to an adjacent main frame module. For example, a middle main frame module may be connected to at least two of an adjacent inboard main frame module, an adjacent middle main frame module, and an adjacent outboard main frame module. The releasable connection facilitates simple reconfiguration of the mould assembly.

In some examples, the mould assembly may comprise a plurality of substantially identical middle main frame modules. In some examples, the or each middle main frame module may have a chordwise width that is smaller than a chordwise width of the or each inboard main frame module. Further, the or each middle main frame module may have a chordwise width that is larger than a chordwise width of the or each outboard main frame module.

In some examples, each intermediate support structure may comprise a plurality of chordwise-extending ribs that are mutually spaced in the spanwise direction. The chordwise ribs may provide structural support to the mould skin in portions of the mould where such support is most advantageous. This may help to provide a substantially lightweight means for supporting the mould skin. Further, the chordwise ribs may be shaped to help maintain the dimensional accuracy of the mould skin. As such, in some examples an upper edge of each chordwise rib may substantially match a contour of the reverse side of a portion of the skin section supported by the chordwise rib.

In some examples, each intermediate support structure may comprise a plurality of support pipes, rods or beams that extend longitudinally in the spanwise direction. The support pipes, rods or beams may provide structural support and rigidity to the intermediate support structure, and thereby also to the mould skin, in the spanwise direction. In examples where the intermediate support structure comprises chordwise ribs, the support pipes, rods or beams are preferably attached to the ribs. As such the support pipes, rod or beams may help to maintain the position of each chordwise rib relative to the other chordwise ribs in the intermediate support structure. In some examples, each support pipe, rod or beam may extend between adjacent chordwise ribs to space the ribs apart and maintain their relative separation. In some examples the support pipes, rods or beams may be permanently attached to the ribs, for example by welding or adhesive bonding. In some examples

In some examples, the main frame modules may be substantially rectangular in plan view. It will be appreciated that “substantially rectangular” includes square, i.e. square-shaped main frame modules. A substantially rectangular shape may be advantageous when transporting and storing the main frame modules and may also facilitate simple alignment of adjacent main frame modules when assembling the reconfigurable mould assembly.

In some examples, the mould assembly may further comprise a plurality of turners configured to turn the mould assembly to position the mould skin on top of a corresponding mould skin shaped to form a second half shell of the blade. The turners may be spaced apart in the spanwise direction. In preferred examples, each turner may comprise a turner beam configured to engage with a respective main frame module.

In some examples each main frame module may include a window to receive or engage a respective turner beam. In preferred examples there may be one or more vacant windows between adjacent turners. A “window” of a main frame module is a portion of the module that is configured for attaching a turner, for example a turner beam of the turner, to the module. In some examples, the windows of the main frame modules may comprise structurally reinforced portions of the respective main frame module. Providing a plurality of windows at which a turner attached provides greater flexibility in the positioning of the turners. As such, each turner can be positioned in an optimal position for loading, thereby reducing the number of turners required in some examples and/or ensuring that each turner is appropriately loaded to avoid damaging the turners in use. In particular, this facilitates repositioning the turners as required when the mould assembly is reconfigured to form different wind turbine blades.

In some examples, a plurality of inboard turners may be provided in an inboard section of the mould assembly. Additionally or alternatively, a plurality of outboard turners may be provided in an outboard section of the mould assembly. Additionally or alternatively, a plurality of middle turners may be provided in a middle section of the mould assembly. In preferred examples, the turner beams of each inboard turner may be of equal length in the chordwise direction. Additionally or alternatively, the turner beams of each outboard turner may be of equal length in the chordwise direction. Additionally or alternatively, the turner beams of each middle turner may be of equal length in the chordwise direction. This configuration is particularly advantageous in examples wherein each main frame module of a given section has the same chordwise width as described above.

Another aspect of the invention relates to use of the mould assembly described herein for making a wind turbine blade.

For example, in another aspect of the invention there is provided a method of making wind turbine blades of different dimensions using the mould assembly described herein. The method comprises using the mould assembly to make a first wind turbine blade having a first size. Subsequently, the method comprises reconfiguring the mould assembly by exchanging a mould skin section with a different mould skin section having different dimensions. Further, the method then comprises making a second wind turbine blade using the mould assembly, such that the first and second wind turbine blades have different dimensions.

The method may further comprise exchanging an intermediate support structure with a different intermediate support structure. For example, the method may comprise disconnecting an intermediate support structure from a main frame module and subsequently releasably connecting a different intermediate support structure to the main frame module. The method preferably comprises releasably connecting each intermediate support structure to one or more main frame modules.

In some examples, the step of reconfiguring the mould assembly may include adding or subtracting one or more main frame modules. For example, the method may comprise disconnecting a main frame module from an adjacent main frame module. The method may further comprise releasably connecting one or more additional main frame modules to an adjacent main frame module to increase the length of the mould assembly to manufacture a larger blade. Alternatively, after disconnecting a main frame module from an adjacent main frame module, the method may comprise removing one or more main frame modules and either a) replacing them with fewer or shorter main frame modules, or b) not replacing the removed frame modules. Accordingly, such examples may involve reconfiguring the mould assembly to forma shorter wind turbine blade. In the case of b), two existing main frame modules may be releasably connected together, or if the method involves removing the most inboard or most outboard main frame module, there may simply be no further reconnection step with the combined length of the main frame modules having been thereby reduced.

According to another aspect of the invention there is provided a method of making a mould assembly for a wind turbine blade half shell. The method comprises providing an elongate mould plug at a first location. The mould plug has a profile corresponding to part of a profile of a wind turbine blade half shell. The method further comprises forming a mould skin section on the mould plug. The method comprises providing a frame structure on top of the mould skin section on the plug and attaching the frame structure to the mould skin section to form a sub-assembly comprising the mould skin section and the frame structure. The method further comprises removing the sub-assembly from the mould plug and transporting the sub-assembly from the first location to a blade manufacturing facility. The method further comprises arranging the sub-assembly end to end with one or more further sub-assemblies at the blade manufacturing facility to form a mould assembly for a wind turbine blade half shell having a first geometry.

In some examples, the step of forming the mould skin on the plug may comprise providing fibrous reinforcing material on the mould plug, providing resin to the fibrous material, and at least partially curing the resin. The resin may be provided to the fibrous reinforcing material in a resin infusion process, for example under a vacuum. Alternatively or additionally, the fibrous reinforcing material may already contain resin before it is provided on the mould plug, e.g. it may be ‘prepreg’ material, which is fibre-reinforced material that is pre-impregnated with resin. The method may comprise removing the sub-assembly from the mould plug when the resin is fully cured, or when the resin is only partially cured.

In some examples, the step of providing the frame structure on top of the mould skin section may comprise lifting the frame structure, optionally turning the frame structure, positioning the frame structure above the plug, and lowering the frame structure onto the mould skin section. For example, the method may comprise lifting and lowering the frame structure using a bridge crane or overhead crane.

In some examples, the step of removing the sub-assembly from the mould plug may comprise lifting the sub-assembly from the mould plug. It will be appreciated that removing the sub-assembly from the plug involves removing the mould skin section from the plug. As such, to facilitate removal of the mould skin section from the plug, the method may comprise an initial step of applying a release layer, or release agent to the mould plug before forming the mould skin section on the mould plug.

In some examples, the mould skin section may be shaped to form a root end of the half shell or a tip end of the half shell or at least part of a middle section of the half shell between the root end and the tip end.

In some examples, the first location at which the mould plug is provided may be within the same site, or same building, as the blade manufacturing facility. As such, the method may comprise transporting the sub-assembly a short distance from the first location to the blade manufacturing facility. In some examples, the steps of removing the sub-assembly from the mould plug and transporting the sub-assembly the blade manufacturing facility may be performed in a single operation. For example, the sub-assembly may be removed from the mould plug using a bridge crane, and subsequently the bridge crane may transport the sub-assembly to the blade manufacturing facility.

In other examples, the blade manufacturing facility may be in a location remote from the first location. For example, the blade manufacturing facility and the first location may be located in different factories or buildings, which may be in different locations of a site, or in different cities or in different countries in some examples.

In examples wherein the blade manufacturing facility is remote from the first location, the method may further comprise arranging the sub-assembly in a transport container and transporting the sub-assembly inside the container from the first location to the blade manufacturing facility. As such, in preferred examples the sub-assembly, i.e. the mould skin section and frame structure may be configured to fit inside a transport container. Advantageously a transport container protects the subassembly, and in particular the mould skin section, during transport.

The sub-assembly may be transported by road, rail, air or sea from the first site to the blade manufacturing facility in some examples. Accordingly, configuring the sub-assembly to fit inside a transport container, i.e. a shipping container, may facilitate simple and cost effective transport of the sub assembly because methods of transporting such containers are already well established and do not require special measures. Providing the mould skin of the mould assembly as a plurality of mould skin sections therefore offers more freedom for transporting the mould skin, and facilitates the manufacture of the skin sections in a different location to the blade manufacturing facility. The mould skin sections may therefore be produced in a specialist facility that is optimised for manufacturing such components, and the blade manufacturing facility need not additionally house mould manufacturing apparatus.

In some examples, the frame structure may comprise one or more main frame modules releasably connected to an intermediate support structure. Accordingly, the method may further comprise connecting the intermediate support structure to the mould skin section in some examples. In preferred examples, the method may comprise releasably connecting the intermediate support structure to the mould skin section.

The mould skin section may have a front side facing the mould plug and a reverse side opposite the front side. In preferred examples, the front side may have a generally concave profile, whereas the reverse side may have a generally convex profile. In preferred examples the method may further comprise connecting the intermediate support structure to the reverse side of the mould skin section. For example the reverse side of the mould skin section may comprise a plurality of attachment tabs. The method may comprise releasably connecting the intermediate support structure to the plurality of attachment tabs for example via a bolted connection.

In some examples, the method may comprise connecting the intermediate support structure to the mould skin section before connecting the intermediate support structure to the one or more main frame modules. However, in preferred examples, the method may comprise releasably connecting the intermediate support structure to the one or more main frame modules before connecting the intermediate support structure to the mould skin section. For example, the intermediate support structure may be bolted to the one or more main frame modules to form the frame structure before said frame structure is provided on top of the mould skin section on the plug. Advantageously this means that the main frame module(s) and support structure are lifted in a single operation, thereby reducing the time required for aligning components on the plug, and thereby reducing the amount of time that the plug is occupied by a given mould skin section.

In some examples, the or each intermediate support structure may comprise a plurality of chordwise extending ribs that are mutually spaced in a spanwise direction. Additionally or alternatively, the or each intermediate support structure may comprise a plurality of pipes, rods or beams that extend longitudinally in the spanwise direction. The method may comprise connecting the chordwise extending ribs and/or spanwise extending pipes, rods or beams to the mould skin section.

In some examples, the method may further comprise releasably connecting a main frame module of the sub-assembly with a main frame module of a further sub-assembly at the blade manufacturing facility. Additionally or alternatively, the method may comprise releasably connecting the intermediate support structure of the sub-assembly with an intermediate support structure of the further sub-assembly. Accordingly, the method may comprise releasably connecting the sub-assembly to one or more further sub-assemblies at the blade manufacturing facility to form the mould assembly. Releasably connecting the sub-assembly to another subassembly, by releasably connecting main frame modules and/or intermediate support structures of adjacent sub-assemblies facilitates reconfiguration of the mould assembly for forming different wind turbine blades.

In some examples, the frame structure may further comprise one or more turner beams attached to the one or more main frame modules. Such a configuration advantageously minimises the time required for assembling the mould assembly at the blade manufacturing facility, because the sub-assembly is provided to the blade manufacturing facility with the or each turner beam already attached to the one or more main frame modules. Additionally or alternatively the frame structure may comprise one or more lifting beams for lifting the frame structure. Such lifting means may provide suitable locations for attaching lifting equipment to the sub-assembly to avoid damage to the sub-assembly during transport and positioning of the sub-assembly.

In some examples, the method may further comprise reconfiguring the mould assembly at the blade manufacturing facility such that the mould assembly is suitable for making a wind turbine blade half shell having a second geometry that is different to the first geometry.

For example, reconfiguring the mould assembly may comprise detaching or disconnecting the intermediate support structure of the sub-assembly from the one or more main frame modules, removing the mould skin section and the attached intermediate support structure from the mould assembly, providing a different mould skin section attached to an intermediate support structure, and connecting the intermediate support structure of the different mould skin section to the one or more main frame modules.

The method may further comprise releasably connecting the intermediate support structure of the different mould skin section to the one or more main frame modules. For example, the intermediate support structure of the different mould skin section may be connected to the one or more main frame modules via a bolted connection.

In some examples, the second geometry may be longer than the first geometry, i.e. the wind turbine blade half shell having the second geometry may be longer than the wind turbine blade half shell having the first geometry. In such an example, the method may comprise adding an additional main frame module to the mould assembly and additionally connecting the intermediate support structure of the different mould skin section to the additional main frame module.

In other examples, the second geometry may be shorter than the first geometry, i.e. the wind turbine blade half shell having the second geometry may be shorter than the wind turbine blade half shell having the first geometry. In such an example, the method may comprise removing a main frame module from the mould assembly.

In some examples the different mould skin section may be provided on a transport tool that is releasably connected to the intermediate support structure of the different mould skin section. The transport tool may advantageously provide the requisite structural support to the mould skin section and/or intermediate support structure during transport thereof, i.e. prior to connecting the intermediate support structure of the different mould skin section to the one or more main frame modules. In preferred examples the method may comprise releasing the different mould skin section from the transport tool prior to connecting the intermediate support structure of the different mould skin section to the one or more main frame modules to form the mould assembly.

### BRIEF DESCRIPTION OF THE DRAWINGS

Examples of the present invention will now be described by way of non-limiting example only, with reference to the accompanying figures, in which:

FIG. 1 is a schematic exploded view of a wind turbine blade;

FIG. 2 is a schematic perspective view of a reconfigurable mould assembly comprising a mould skin, an intermediate support structure and a main frame;

FIG. 3 is a schematic perspective view of the reconfigurable mould assembly with an inboard portion of the mould assembly shown in a schematic exploded view;

FIG. 4a is a schematic perspective view of a main frame module;

FIG. 4b is a schematic perspective view of a plurality of main frame modules arranged together to form a portion of the main frame;

FIGS. 5a to 5c respectively show schematic side views of an inboard portion, a middle portion, and a outboard portion of the mould assembly;

FIG. 6 is a schematic end view of the mould assembly showing a turner configured for turning the mould assembly;

FIG. 7 is a schematic side view of the reconfigurable mould assembly;

FIG. 8 is a schematic plan view of the reconfigurable mould assembly;

FIGS. 9a to 9c schematically illustrate a process of manufacturing a subassembly of the mould assembly;

FIG. 10 is a schematic perspective view showing a stage in the reconfiguration of the mould assembly; and

FIGS. 11a to 11c schematically illustrate a process of manufacturing a different mould skin section for replacing an existing mould skin section when reconfiguring the mould assembly.

### DETAILED DESCRIPTION

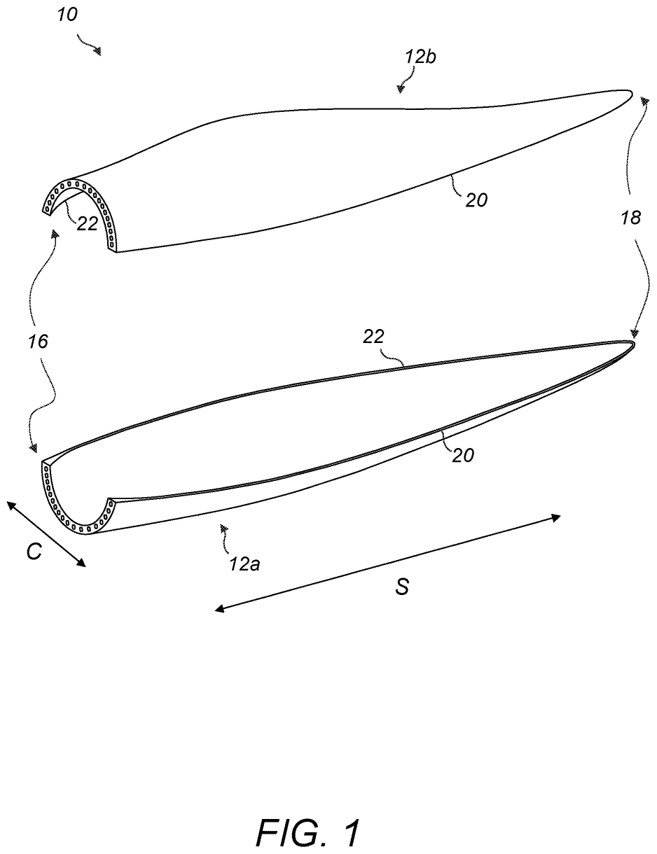

FIG. 1 shows a schematic exploded view of a wind turbine blade 10. The blade 10 comprises a first half shell 12a and a second half shell 12b which are joined together to form an outer shell of the blade 10. Each half shell 12a, 12b extends longitudinally in a spanwise direction (S) from a root end 16 to a tip end 18, and transversely in a chordwise direction (C) between a leading edge 20 and a trailing edge 22. The root end 16 of the blade 10 is preferably configured for attachment to a rotor hub of a wind turbine (not shown). Accordingly, the root end 16 may be referred to as an inboard end of the blade 10, and the tip end 18 may be referred to as an outboard end of the blade 10.

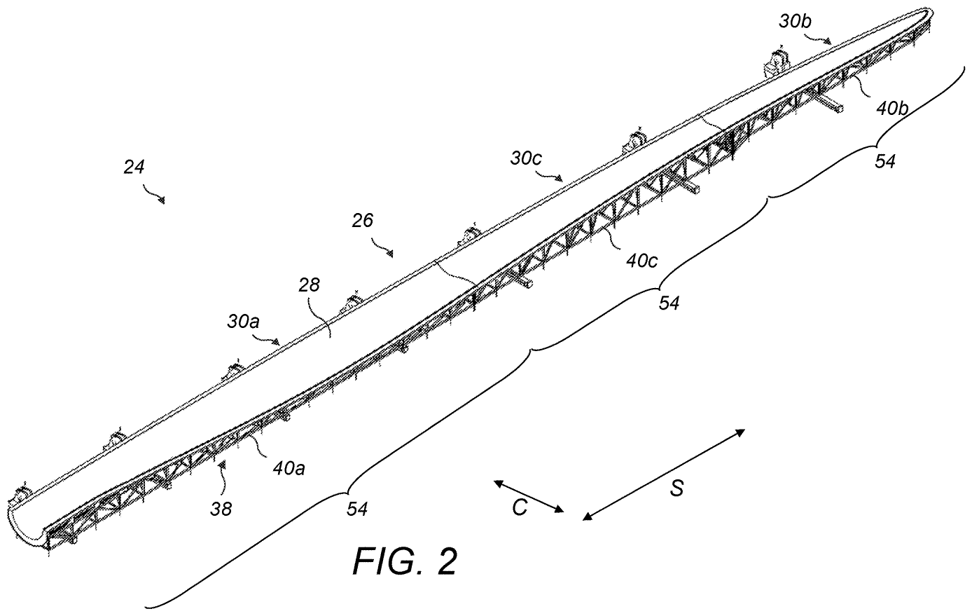

The half shells 12a, 12b each comprise an outer profile that defines part of the aerodynamic profile of the blade 10 when the half shells 12a, 12b are joined together. Each half shell 12a, 12b may be manufactured separately before the half shells 12a, 12b are joined together to form the outer shell of the blade 10. The half shells 12a, 12b may be manufactured using a reconfigurable mould assembly 24 which will now be described with reference to FIGS. 2 to 8.

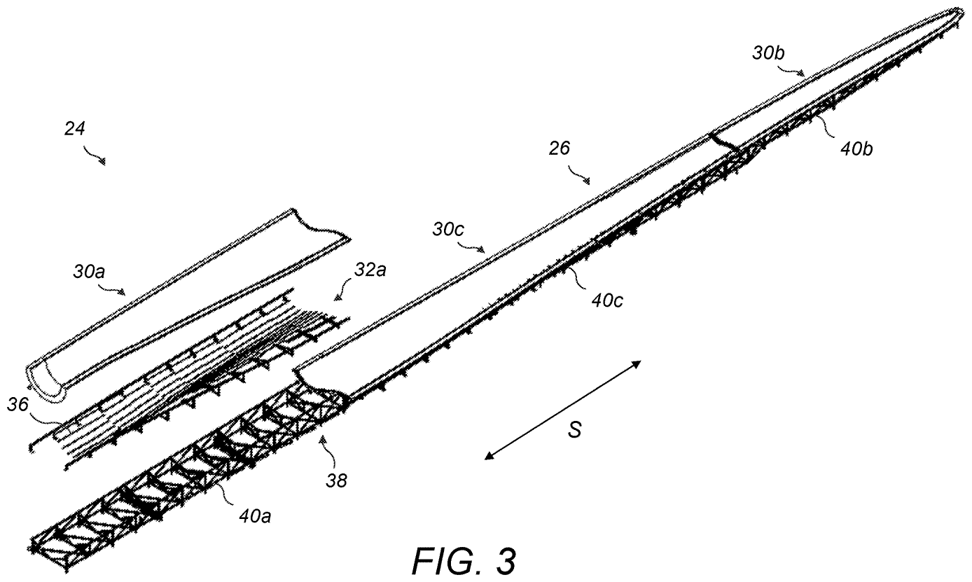

Reference is made initially to FIGS. 2 and 3 which show an example of a reconfigurable mould assembly 24 in a schematic perspective view and a schematic exploded view respectively. The reconfigurable mould assembly 24 comprises a mould skin 26 defining a mould surface 28 shaped to form a half shell 12 of a wind turbine blade 10, such as the half shells 12a, 12b of the blade 10 shown in the example of FIG. 1. The mould skin 26 extends longitudinally in a spanwise direction (S) and transversely in a chordwise direction (C).

The mould skin 26 comprises a plurality of spanwise sections 30 for arrangement end to end in the spanwise direction (S) to form the half shell 12. The mould assembly 24 includes at least one inboard skin section 30a for forming the root end 16 of the half shell 12, and at least one outboard skin section 30b for forming the tip end 18 of the half shell 12. In some examples, as shown in FIGS. 2 and 3, the mould assembly 24 may also include a middle skin section 30c for forming at least part of a middle section of the half shell 12 between the root end 16 and the tip end 18.

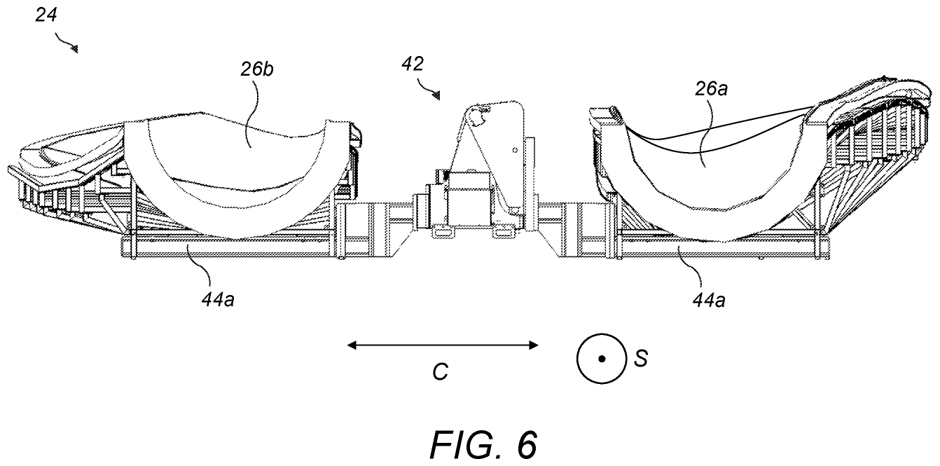

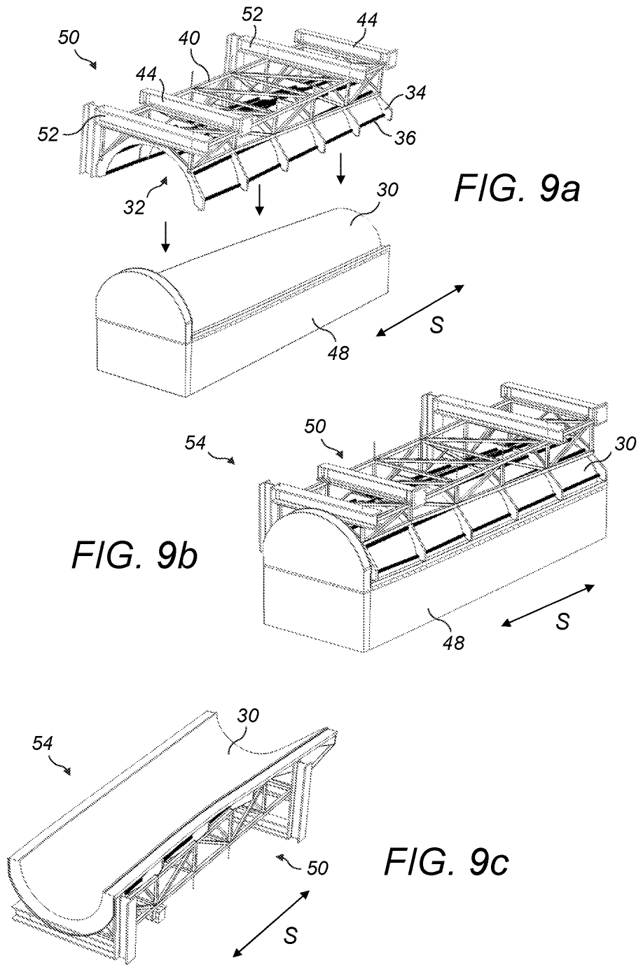

The mould assembly 24 further includes an intermediate support structure 32a-c attached to a reverse side of each mould skin section 30a-c. The intermediate support structures 32a-c support the mould skin sections 30a-c to help maintain the dimensional accuracy of the mould skin 26 when manufacturing a half shell 12. Accordingly, the intermediate support structures 32a-c may comprise a plurality of chordwise-extending ribs 34 (shown most clearly in FIGS. 6 and 9a) that are mutually spaced in the spanwise direction (S). Further, as shown in FIG. 3 for example, the intermediate support structures 32a-c may comprise a plurality of support pipes, rods or beams 36 that extend longitudinally in the spanwise direction (S), in some examples.

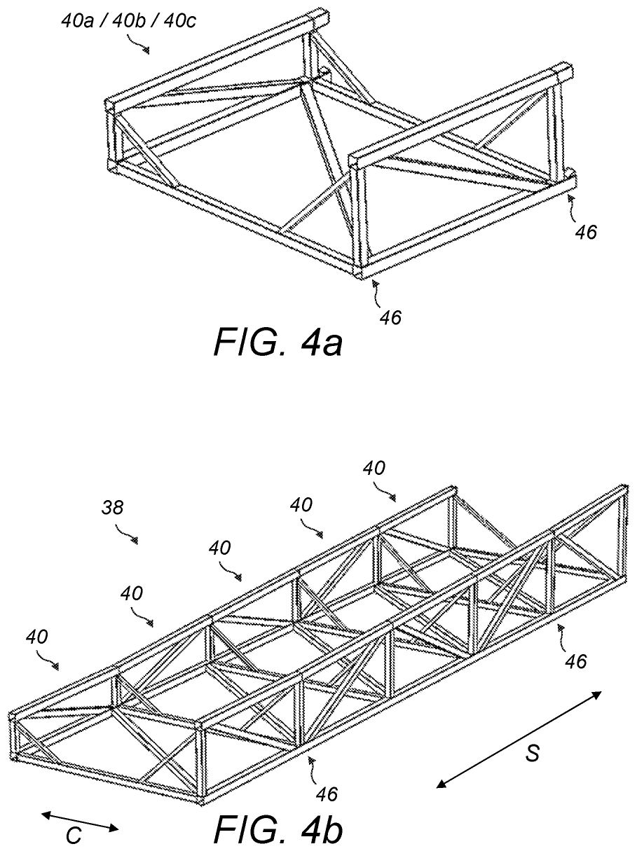

With additional reference to FIGS. 4a and 4b, the mould assembly 24 further comprises a main frame 38 which supports the intermediate support structures 32a-c and the mould skin 26. The main frame 38 comprises a series of independent main frame modules 40a-c, shown in FIG. 4a, which are arranged end to end in the spanwise direction (S) to form the main frame 38, a portion of which is shown in FIG. 4b. For example, the mould assembly 24 includes at least one inboard main frame module 40a for supporting the or each inboard skin section 30a and at least one outboard main frame module 40b for supporting the or each outboard skin section 30b. In some examples, the mould assembly 24 may also include one or more middle main frame modules 40c for supporting the middle skin section 30c.

To facilitate simple reconfiguration of the mould assembly 24 to manufacture different wind turbine blades 10 having different geometries, the intermediate support structures 32a-c are releasably attached to the main frame 38, i.e. to the main frame modules 40a-c. For example, the intermediate support structure(s) 32a attached to the inboard skin section(s) 30a are releasably connectable to the inboard main frame module(s) 40a, and the intermediate support structure(s) 32b attached to the outboard skin section(s) 30b are releasably connectable to the outboard main frame module(s) 40b. In examples comprising an intermediate support structure 32c attached to a reverse side of the middle skin section 30c, such an intermediate support structure 32c is preferably similarly releasably connectable to the one or more middle main frame modules 40c. The releasable connection between the intermediate support structures 32a-c and the respective main frame modules 40a-c facilitates a simple substitution of different mould skin sections 30a-c and intermediate support structures 32a-c to form blades 10 having different geometries using the mould assembly 24.

Referring still to FIGS. 4a and 4b, in some preferred examples the main frame modules 40a-c are substantially rectangular in plan view. This is advantageous for aligning the main frame modules 40a-c to form the main frame 38, and also for transport and storage of the main frame modules 40a-c. In some examples, the main frame modules 40a-c may be releasably connected to one another, i.e. adjacent main frame modules 40a-c may be releasably connected together. Such a configuration may provide additional rigidity to the mould assembly 24 whilst still facilitating simple reconfiguration of the mould assembly 24 as required.

The mould skin 26, i.e. the plurality of mould skin sections 30a-c, may not be directly connected to the main frame modules 40a-c in some advantageous examples. For example, the provision of the intermediate support structures 32a-c decouples or somewhat dissociates the main frame modules 40a-c from the mould skin 26. As such, the main frame modules 40a-c are not directly influenced by the varying profile of the mould skin 26. Instead, the intermediate support structures 32a-c absorb the changing geometry of the mould skin 26 along its length and provide a substantially uniform interface for connecting to the main frame modules 40a-c.

As such, in preferred examples, the main frame modules 40a-c in each spanwise section of the mould assembly 24 may have substantially identical dimensions. This modularity reduces engineering effort and costs associated with manufacturing each main frame module design.

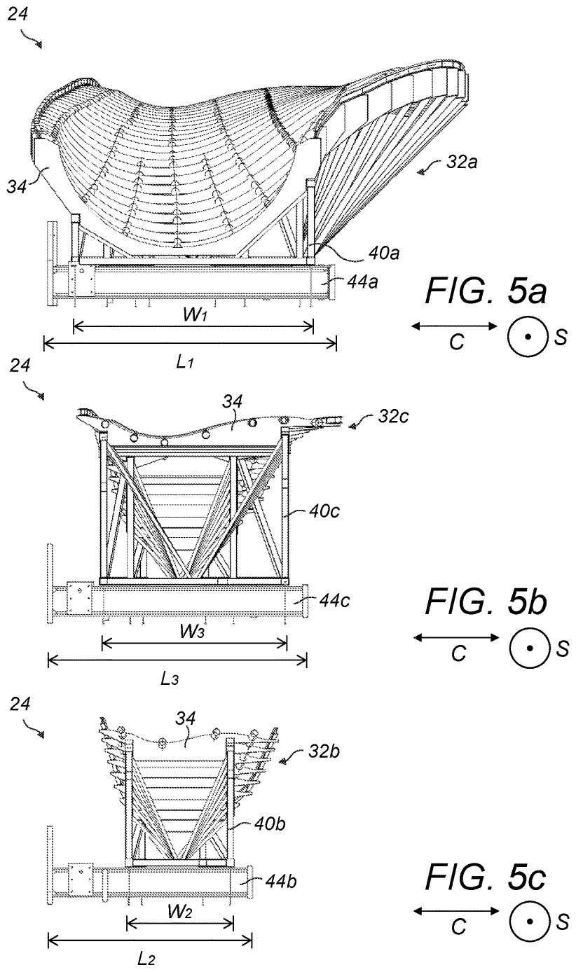

For example, each inboard main frame module 40a preferably has a substantially identical chordwise width W₁ as shown in the schematic side view of FIG. 5a, which shows a portion of the mould assembly 24 comprising inboard main frame modules 40a and attached intermediate support structures 32a. Each inboard main frame module 40a preferably has a chordwise width W₁ that is larger than a chordwise width W₂ of the or each outboard main frame module 40b.

With reference to FIG. 5b, in examples wherein the mould assembly 24 comprises a plurality of middle main frame modules 40c, such main frame modules 40c are preferably substantially identical, for example each middle main frame module 40c may have a substantially identical chordwise width W₃. Each middle main frame module 40c preferably has a chordwise width W₃ that is smaller than a chordwise width W₁ of each inboard main frame module 40a, and larger than a chordwise width W₂ of each outboard main frame module 40b.

Referring to the schematic side view of FIG. 5c, which shows a portion of the mould assembly 24 comprising outboard main frame modules 40b and attached intermediate support structures 32b, each outboard main frame module 40b preferably has substantially identical dimensions. For example, each outboard main frame module 40b preferably has a substantially identical chordwise width W₂.

The forgoing description of the mould assembly 24 has been provided with reference to a mould skin 26 defining a mould surface 28 shaped to form a half shell 12a of a wind turbine blade 10. Referring now to FIGS. 6, 7 and 8, in some examples, the mould assembly 24 may include a plurality of turners 42 configured to turn the mould assembly 24 to position the mould skin 26a on top of a corresponding mould skin 26b shaped to form a second half shell 12b of the blade 10. For example, manufacturing a wind turbine blade 10 may involve forming a half shell 12a, 12b on each mould skin 26a, 26b. Subsequently the turners 42 may arrange the mould skin 26a on top of the second mould skin 26b such that the half shell 12a formed on the mould skin 26a is arranged on top of the half shell 12b formed on the second mould skin 26b.

The turners 42 are preferably spaced apart in the spanwise direction (S) to distribute the load of the mould assembly 24 across the turners 42. The mould assembly 24 preferably includes one or more inboard turners 42a provided in an inboard section of the mould assembly 24. Further, one or more outboard turners 42b may be provided in an outboard section of the mould assembly 24, and one or more middle turners 42c may be provided in a middle section of the mould assembly 24. Each turner 42a-c is preferably configured to engage with a respective main frame module 40a-c. For example, each turner 42a-c preferably comprises a turner beam 44a-c extending in the chordwise direction (C) for attachment to a main frame module 40a-c. Advantageously, the turner beams 44a-c may be releasably connected to the main frame modules 40a-c, for example by a bolted connection, again facilitating simple reconfiguration of the mould assembly 24 when required.

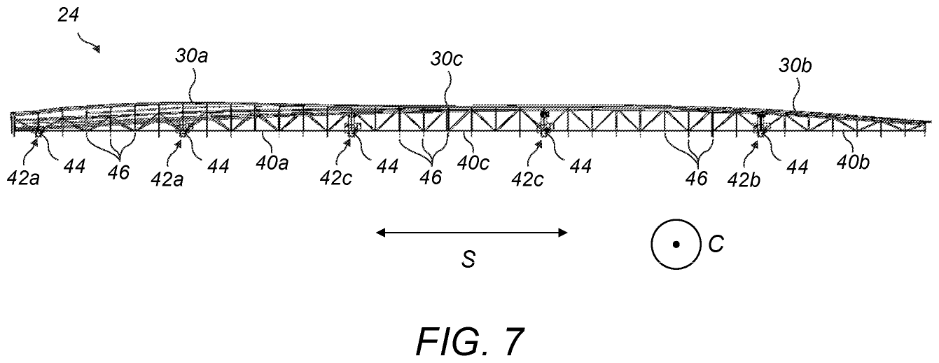

For connecting a turner 42, each main frame module 40a-c preferably comprises a “window” 46, i.e. an attachment location, which may comprise a structurally reinforced portion of the main frame module 40a-c for engaging a turner beam 44a-c. Forming the main frame 38 of a plurality of main frame modules 40a-c advantageously provides a plurality of windows 46 for attaching turner beams 44. As shown most clearly in the schematic side view of the mould assembly 24 in FIG. 7, the mould assembly may therefore comprise one or more vacant windows 46 between adjacent turners 42. The attachment windows 46 provided by each main frame module 40a-c further facilitate reconfiguration of the mould assembly 24 for forming blades 10 of different geometries, because the turners 42 can be repositioned along the mould assembly 24 in accordance with the loading requirements of each mould configuration.

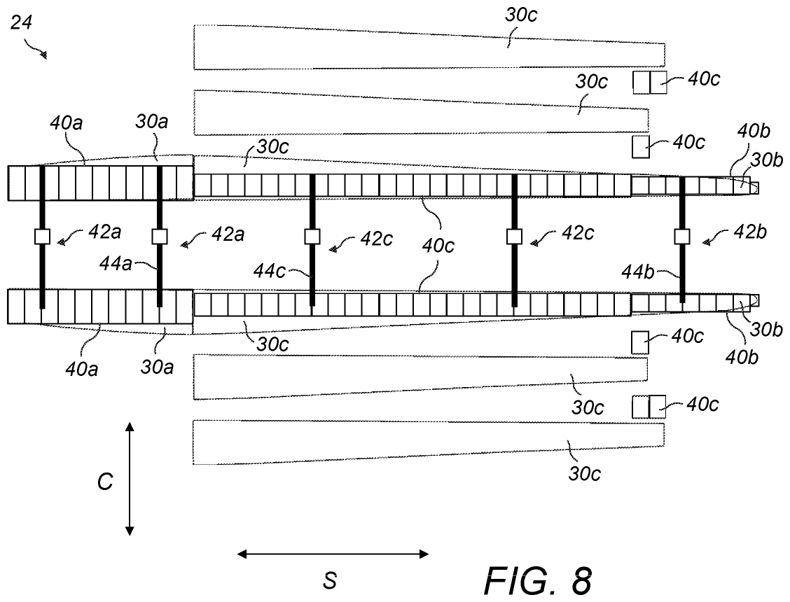

Briefly referring back to FIGS. 5a to 5c, in addition to FIG. 8, the turner beams 44a of the inboard turners 42a are preferably of equal length L₁ in the chordwise direction (C). The turner beams 44b of the outboard turners 42b are preferably also of equal length L₂ to one another in the chordwise direction (C). Similarly, the turner beams 44c of the middle turners 42c are preferably of equal length L₃ in the chordwise direction (C). In some examples, the chordwise length L of each turner beam 44a-c may be dictated by, or at least related to, the chordwise width W of the main frame module 40a-c to which it is attached.

The preferred examples described previously, wherein each main frame module 40a-c in a respective spanwise section of the mould assembly 24 has the same chordwise width W, may therefore be further advantageous for reconfiguring the mould assembly 24. For example, such a configuration may mean that each inboard turner 42a can be attached to any inboard main frame module 40a, each outboard turner 42b can be attached to any outboard main frame module 40b, and where included, each middle turner 42c can be attached to any middle main frame module 40c.

Referring now more specifically to the schematic plan view of the reconfigurable mould assembly 24 in FIG. 8, it will be explained how the mould assembly 24 may be used to manufacture wind turbine blades 10 having different geometries. As previously described, the mould assembly 24 may be used to form a first half shell 12a and a second half shell 12b before these are joined together to form the outer shell of the blade 10. As such, the mould assembly 24 may be used to make a first wind turbine blade 10.

Subsequently, the mould assembly 24 may be reconfigured to make a second wind turbine blade 10 having different dimensions to the first blade 10. For example, one or more mould skin sections 30a-c may be exchanged with one or more different mould skin sections 30a-c having different dimensions. In some examples this may also involve exchanging one or more intermediate support structures 32a-c with one or more different intermediate support structures 32a-c (not shown) to support the different skin section(s) 30a-c. In the example shown in FIG. 8, a plurality of different middle skin sections 30c are provided to exchange for the existing middle skin section 30c of the mould assembly 24 to manufacture blades 10 of different lengths. It will be appreciated that in other examples, any combination of one or more skin sections 30a-c may be exchanged for a different skin section 30a-c.

With the mould assembly 24 reconfigured with one or more different mould skin sections 30a-c, the mould assembly 24 may then be used to make a second wind turbine blade 10.

For example, this may involve arranging reinforcing material on the mould skin 26 and integrating the reinforcing material with a resin to form a half shell 12 having different dimensions to the half shell 12 of the first blade 10. Accordingly, the first and second wind turbine blades 10 may advantageously have different dimensions.

It should be noted that reconfiguring the mould assembly 24 does not necessarily require reconfiguration of the main frame 38. Different mould skin sections 30a-c and corresponding intermediate support structures 32a-c may be releasably connected to the existing main frame 38. As such, blades 10 with different geometries can be manufactured in the mould assembly 24 without changing the main frame 38.

However, in some other examples, the second blade 10 may be a different length to the first blade 10, or at least one of the different mould skin sections 30a-c may be a different length to the corresponding mould skin section 30a-c for the first blade 10. In such examples, reconfiguring the mould assembly 24 may include adding or subtracting one or more main frame modules 40a-c. As shown in FIG. 8, a plurality of different main frame modules, such as inboard and/or outboard and/or middle main frame modules 40a-c may be provided for inclusion in the mould assembly 24 when required for supporting skin sections 30a-c for forming different blades 10 of different lengths. In the case of including an additional main frame module 40a-c, the reconfiguration of the mould assembly 24 may involve connecting the different intermediate support structure 32a-c of the different mould skin section 30a-c to the additional main frame module 40a-c.

It should therefore be understood that the mould assembly 24 described herein facilitates simple reconfiguration for forming different blades 10 having different geometries. This significantly reduces mould downtime when reconfiguring the mould assembly 24 to form different blades 10, and also reduces cost and engineering effort involved in producing different mould assemblies 24. In particular, the reconfigurable mould assembly 24 facilitates reconfiguration of any spanwise portion of the mould assembly 24, such as an inboard portion, an outboard portion, or a middle portion for example, by exchanging one or more mould skin sections 30a-c and/or adding or removing one or more main frame modules 40a-c. A method of making a mould assembly 24 for a wind turbine blade half shell 12 will now be described with reference to the remaining figures.

As shown in FIG. 9a, an elongate mould plug 48 is provided at a first location. The mould plug 48 has a profile corresponding to part of a profile of a wind turbine blade half shell 10. The mould plug 48 may define a substantially convex profile and may be referred to as a male mould. A mould skin section 30, such as the mould skin sections 30-a-c described previously with reference to FIGS. 2 to 8, is formed on the mould plug 48. For example, the mould skin section 30 may be a composite structure, and may be formed by arranging fibrous material, such as glass fiber, on the mould plug 48 before integrating the fibrous material with a polymer resin.

The mould skin section 30 formed on the mould plug 48 may be shaped to form a root end 16 of the half shell 12, a tip end 18 of the half shell 12, or at least part of a middle section of the half shell 12 between the root end 16 and the tip end 18. It will be appreciated that the same method may be used to form each skin section 30a-c of the mould assembly 24, although a different mould plug profile may be required for each different mould skin section 30a-c.

Referring still to FIG. 9a, after forming the mould skin section 30, a frame structure 50 is provided on top of the mould skin section 30 on the plug 48. The frame structure 50 may be lifted (and in some examples turned) and positioned above the plug 48, and lowered onto the mould skin section 30 to provide the frame structure 50 on top of the mould skin section 30 on the plug 48. In some examples the frame structure 50 may include one or more lifting beams 52 to provide lifting points and protect the frame structure 50 during lifting operations.

In some examples, as shown in FIG. 9a, the frame structure 50 may comprise one or more main frame modules 40 that are releasably connected to an intermediate support structure 32. For example, the intermediate support structure 32 may be bolted to the or each main frame module 40. As described previously, each intermediate support structure 32 may comprise a plurality of chordwise extending ribs 34 that are mutually spaced in the spanwise direction (S). In some examples the intermediate support structure 32 may also include a plurality of pipes, rods or beams 36 that extend longitudinally in the spanwise direction (S), as shown in FIG. 9a.

Additionally, in some examples the frame structure 50 provided on top of the mould skin section 30 may include one or more turner beams 44 attached to the or each main frame module 40. For example, the frame structure 50 may be assembled, including the or each turner beam 44, prior to arrangement on the mould skin section 30 on the mould plug 48. Alternatively, in some examples the or each turner beam 44 may be attached to the or each main frame module 40 after arranging the main frame module(s) 40 and releasably connected intermediate support structure 32 on top of the mould skin section 30 on the plug 48. This may advantageously provide improved access to the main frame module(s) 40 and windows 46 for attaching the or each turner beam 44 to the main frame module(s) 40.

As shown in FIG. 9b, with the frame structure 50 provided on top of the mould skin section 30 on the plug 48, the frame structure 50 is attached to the mould skin section 30 to form a sub-assembly 54. The sub-assembly 54 comprises the mould skin section 30 and the frame structure 50, as shown most clearly in FIG. 9c. Attaching the frame structure 50 to the mould skin section 30 may involve connecting the or each intermediate support structure 32 to the mould skin section 30. The frame structure 50 is preferably releasably attached to the mould skin section 30, for example via a bolted connection. For example, the mould skin section 30 may include a plurality of tabs (not shown) on the reverse side of the mould skin section 30, and the frame structure 50 may be connected to the skin section 30 via the tabs.

Referring now to FIG. 9c, the sub-assembly 54 is removed from the mould plug 48 and transported from the first location to a blade manufacturing facility. It will be appreciated that, with reference also to FIG. 9b, removing the sub-assembly 54 from the mould plug 48 may involve lifting the sub-assembly 54 from the mould plug 48. To transport the sub-assembly 54 from the first location to the blade manufacturing facility, the sub-assembly 54 may be arranged and transported inside a transport container (not shown). This may help to protect the sub-assembly 54, and particularly the mould skin section 30, during transport. Transporting the sub-assembly 54 inside a transport container is further advantageous because well-established container transport methods and routes can be used, without requiring specialist logistics solutions.

Following transport, to form a mould assembly 24 for forming a wind turbine blade half shell 12 having a first geometry, the sub-assembly 54 is arranged end to end with one or more further sub-assemblies 54 at the blade manufacturing facility. An example of a mould assembly 24 comprising a plurality of sub-assemblies 54 arranged end-to-end is shown in FIG. 2. In some examples, a main frame module 40a-c of the sub-assembly 54 may be releasably connected with a main frame module 40a-c of a further sub-assembly 54 at the blade manufacturing facility. Further, for increased rigidity and structural support, the intermediate support structure 32a-c of the sub-assembly 54 may be releasably connected with an intermediate support structure 32a-c of the further sub-assembly 54.

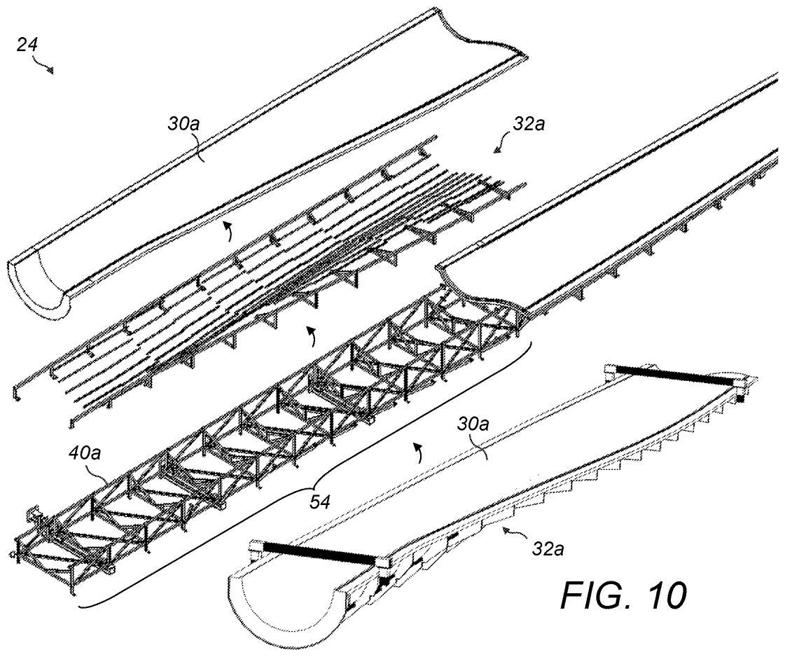

As previously described with reference to FIGS. 2 to 8, the mould assembly 24 may be reconfigured at the blade manufacturing facility such that the mould assembly 24 is suitable for making a wind turbine blade half shell 12 having a second geometry that is different to the first geometry. For example, with reference to FIG. 10, reconfiguring the mould assembly 24 may involve detaching the intermediate support structure 32a-c of a sub-assembly 54 from the one or more main frame modules 40a-c. This may further involve removing the mould skin section 30a-c and the attached intermediate support structure 32a-c from the mould assembly 24. A different mould skin section 30a-c attached to a different intermediate support structure 32a-c may be provided, and said different intermediate support structure 32a-c may be connected, for example bolted, to the one or more existing main frame modules 40a-c.

It will be appreciated that examples involving removing a main frame module 40a-c from the mould assembly 24 to manufacture a shorter blade 10, and others involving adding an additional main frame module 40a-c to the mould assembly 24 to manufacture a longer blade 10, have been described previously with reference to FIG. 8 and will not be described again here in detail.

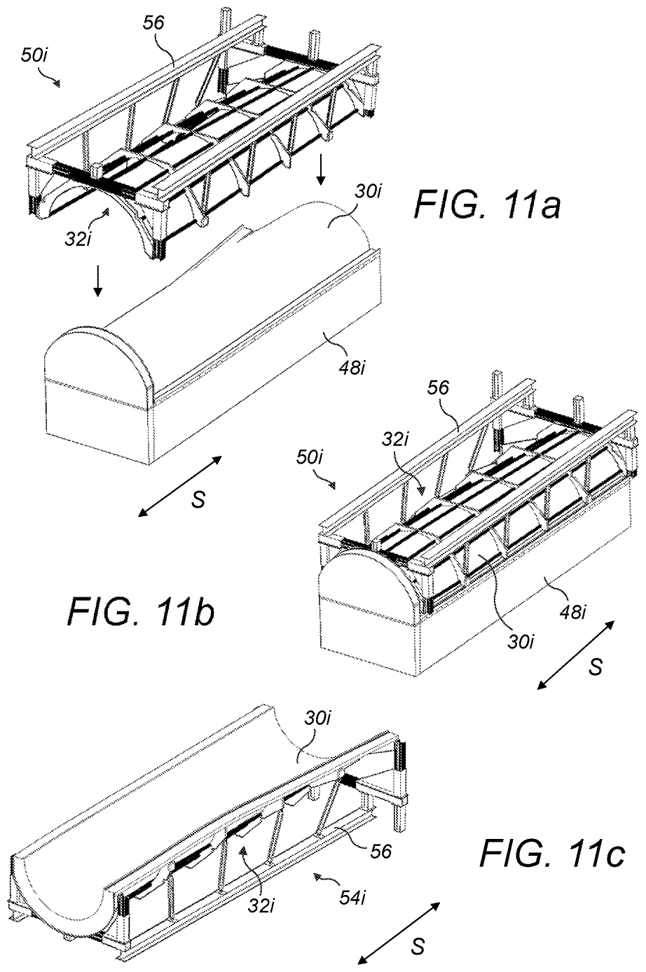

FIGS. 11a to 11c show an example of a process for manufacturing and providing a different mould skin section 30i attached to a different intermediate support structure 32 for reconfiguring the mould assembly 24. Similar to the description provided with reference to FIGS. 9a to 9c, the different mould skin section 30i may be formed on a mould plug 48i and a frame structure 50i may be attached to the different mould skin section 30i, as shown in FIG. 11b.

However, when manufacturing the different mould skin section 30i to exchange for an existing mould skin section 30 of the mould assembly 24, the frame structure 50i may comprise a transport tool 56 instead of one or more main frame modules 40. Accordingly, the frame structure 50i attached to the different mould skin section 30i may comprise a transport tool 56 that is releasably connected to the intermediate support structure 32i of the different mould skin section 30i.

The transport tool 56 may advantageously provide structural rigidity to the different mould skin section 30i and intermediate support structure 32i during transport. Further, the transport tool 56 may additionally provide a plurality of lifting points such that the different mould skin section 30i can be transported and lifted without risking damage to the mould skin section 30i. In some examples, the transport tool 56 may be adjustable, i.e. reconfigurable, such that it can be used for transporting various different mould skin sections 30i and their respective intermediate support structures 32i.

FIG. 11c shows the different mould skin section 30i, attached intermediate support structure 32i and transport tool 56 after these have been lifted from the mould plug 48i. The different mould skin section 30i, intermediate support structure 32i and transport tool 56 may be transported in the same way as the sub-assembly 54 described previously with reference to FIGS. 9a to 9c. The different mould skin section 30i may be released from the transport tool 56 prior to including the different mould skin section 30i in the mould assembly 24. It will be appreciated that the process for including a different mould skin section 30i and associated intermediate support structure 32i has been described previously in detail with reference to FIG. 10 for example, and will not be repeated here for conciseness. Following inclusion of the different mould skin section 30i in the mould assembly 24, the mould assembly 24 may then be used for manufacturing a wind turbine blade half shell 12 having a second geometry that is different to the first geometry.

It will be appreciated that the description provided above serves to demonstrate a plurality of possible examples of the present invention. Features described in relation to any of the examples above may be readily combined with any other features described with reference to different examples without departing from the scope of the invention as defined in the appended claims.

1. A reconfigurable mould assembly for the manufacture of wind turbine blades having different geometries, the mould assembly comprising:
a mould skin extending longitudinally in a spanwise direction and transversely in a chordwise direction, the mould skin defining a mould surface shaped to form a half shell of a wind turbine blade, the mould skin comprising a plurality of spanwise sections for arrangement end to end in a spanwise direction to form the half shell, the plurality of skin sections including one or more inboard skin sections for forming a root end of the half shell, and one or more outboard skin sections for forming a tip end of the half shell;
a main frame comprising a series of independent main frame modules arranged end to end in the spanwise direction, the main frame modules including one or more inboard main frame modules for supporting the one or more inboard skin sections and one or more outboard main frame modules for supporting the one or more outboard skin sections; and
an intermediate support structure attached to a reverse side of each mould skin section,
wherein the intermediate support structure(s) attached to the inboard skin section(s) are releasably connectable to the inboard main frame module(s) and the intermediate support structure(s) attached to the outboard skin section(s) are releasably connectable to the outboard main frame module(s).

2. The mould assembly of claim 1, wherein the mould assembly comprises a plurality of inboard main frame modules having substantially identical dimensions and/or a plurality of outboard main frame modules having substantially identical dimensions.

3. The mould assembly of claim 1, wherein the or each inboard main frame module has a chordwise width that is larger than a chordwise width of the or each outboard main frame module.

4. The mould assembly of claim 1, wherein the mould assembly further comprises:
a middle skin section for forming at least part of a middle section of the half shell between the root end and the tip end;
one or more middle main frame modules for supporting the middle skin section; and
an intermediate support structure attached to a reverse side of the middle skin section,
wherein the intermediate support structure is releasably connectable to the one or more middle main frame modules.

5. The mould assembly of claim 4, wherein the mould assembly comprises a plurality of substantially identical middle main frame modules.

6. The mould assembly of claim 4, wherein the or each middle main frame module has a chordwise width that is smaller than a chordwise width of the or each inboard main frame module, and larger than a chordwise width of the or each outboard main frame module.

7. The mould assembly of claim 1, wherein each intermediate support structure comprises a plurality of chordwise-extending ribs that are mutually spaced in the spanwise direction.

8. The mould assembly of claim 1, wherein each intermediate support structure comprises a plurality of support pipes, rods or beams that extend longitudinally in the spanwise direction.

9. The mould assembly of claim 1, wherein the main frame modules are substantially rectangular in plan view.

10. The mould assembly of claim 1, further comprising a plurality of turners configured to turn the mould assembly to position the mould skin on top of a corresponding mould skin shaped to form a second half shell of the blade, wherein the turners are spaced apart in the spanwise direction, and wherein each turner comprises a beam configured to engage with a respective main frame module.

11. The mould assembly of claim 10, wherein each main frame module includes a window to receive or engage a respective turner beam, and wherein there are one or more vacant windows between adjacent turners.

12. The mould assembly of claim 10, wherein a plurality of inboard turners are provided in an inboard section of the mould assembly and/or a plurality of outboard turners are provided in an outboard section of the mould assembly and/or a plurality of middle turners are provided in a middle section of the mould assembly, and wherein the turner beams of each inboard turner are of equal length in the chordwise direction and/or the turner beams of each outboard turner are of equal length in the chordwise direction and/or the turner beams of each middle turner are of equal length in the chordwise direction.

13. (canceled)

14. (canceled)

15. (canceled)

16. A method of making wind turbine blades, comprising:
providing a reconfigurable mould assembly for the manufacture of wind turbine blades having different geometries, the mould assembly comprising:
a mould skin extending longitudinally in a spanwise direction and transversely in a chordwise direction, the mould skin defining a mould surface shaped to form a half shell of a wind turbine blade, the mould skin comprising a plurality of spanwise sections for arrangement end to end in a spanwise direction to form the half shell, the plurality of skin sections including one or more inboard skin sections for forming a root end of the half shell, and one or more outboard skin sections for forming a tip end of the half shell;
a main frame comprising a series of independent main frame modules arranged end to end in the spanwise direction, the main frame modules including one or more inboard main frame modules for supporting the one or more inboard skin sections and one or more outboard main frame modules for supporting the one or more outboard skin sections; and
a respective intermediate support structure attached to a reverse side of each mould skin section; wherein each intermediate support structure attached to a respective inboard skin section is releasably connectable to the inboard main frame module(s) and each intermediate support structure attached to a outboard skin section is releasably connectable to the outboard main frame module(s); and
configuring the reconfigurable mould assembly into a first configuration; and
making a wind turbine blade of a first dimension.

17. The method of claim 16, further comprising:
reconfiguring the mould assembly into a second configuration by exchanging at least a first spanwise section of the plurality of spanwise sections with a second spanwise section of the plurality of spanwise sections, the second spanwise section having different dimensions than the first spanwise section; and
making a second wind turbine blade using the mould assembly, wherein the second wind turbine blade has a second dimension different from the first dimension.

18. The method of claim 17, wherein reconfiguring the mould assembly includes adding or subtracting one or more main frame modules.
